(19) United States
(12) Patent Application Publication
(10) Pub. No.: US 2025/0200099 A1
(43) Pub. Date: Jun. 19, 2025

(54) AI BASED DOCUMENT CLASSIFICATION METHOD AND A COMPUTING DEVICE

(71) Applicant: WERT INTELLIGENCE CO., LTD., Seoul (KR)

(72) Inventor: JungHo YUN, Seoul (KR)

(73) Assignee: WERT INTELLIGENCE CO., LTD., Seoul (KR)

(21) Appl. No.: 18/979,885

(22) Filed: Dec. 13, 2024

(30) Foreign Application Priority Data
Dec. 13, 2023 (KR) 10-2023-0181294
Dec. 13, 2024 (KR) 10-2024-0186546

(51) Int. Cl. G06F 16/35; G06F 16/38

(52) U.S. Cl. CPC G06F 16/35; G06F 16/38

(57) ABSTRACT

An AI-based document classification method and computing device are disclosed. The AI-based classification method comprises displaying an indication to represent whether an AI model can classify for the classification block selected by the user, and classifying documents selected by the user using the AI model, when a request for document classification with respect to the classification block is received from the user.

### TECHNICAL FIELD

The present invention relates to an AI-based document classification method and a computing device, and more specifically, to a method for automatically classifying a plurality of documents using AI technology.

### BACKGROUND

Patent offices and companies in many countries are looking for ways to efficiently utilize the technical and legal content contained in patent documents. One way to utilize the content is to classify based on the content contained in patent documents.

The method of classifying patent documents was previously conducted through patent attorneys. Patent attorneys classified patent documents by understanding content included in the patent documents and mapping the patent documents to technical classifications. Recently, with the advancement of artificial intelligence (AI) technology, a method of quickly or efficiently classifying patent documents has become possible. However, even if artificial intelligence (AI) technology understands the content of patent documents well, it cannot accurately understand the intention of the user who classifies the patent documents.

Therefore, a method that can reflect the intention of the user is required even when classifying patent documents using artificial intelligence technology.

### DISCLOSURE

### Technical Problem

The present invention may classify a large number of documents more quickly and in accordance with the user's intention by using an AI model learned according to the user's classified intention.

### Technical Solution

According to an embodiment of the present invention, AI (Artificial Intelligence)-based document classification method performed by a computing device comprises: reading a plurality of documents; assigning a user-selected document among the plurality of documents to classification blocks; learning an AI model using the user-selected document assigned to the classification block; notifying whether the AI model classifies the plurality of documents, wherein the AI model learned with the user-selected document in relation to the classification block; and classifying the plurality of documents using the AI model learned with the user-selected document assigned to the classification block, according to a request of the user.

According to an another embodiment of the present invention, An AI (Artificial Intelligence)-based document classification method performed by a computing device comprises: displaying an indication to represent whether an AI model can classify for the classification block selected by the user; and classifying documents selected by the user using the AI model, when a request for document classification with respect to the classification block is received from the user; wherein the AI model is a model learned for association documents with classification blocks, when the user assigns documents to the classification block.

According to an embodiment of the present application, a computing device performing an AI-based document classification method, wherein computing device comprising a processor, wherein the processor is configured to: display an indication to represent whether an AI model can classify for the classification block selected by the user; and classify documents selected by the user using the AI model, when a request for document classification with respect to the classification block is received from the user, wherein the AI model is a model learned for association documents with classification blocks, when the user assigns documents to the classification block.

### Advantageous Effects

According to one embodiment of the present invention, AI model learns the content of a document that a user directly assigns to a classification block, document classification reflecting the user's intention can be performed.

According to one embodiment of the present invention, when a user assigns a document to a classification block, an indication is provided as to whether AI model learning is possible according to the content of the document assigned to the classification block, thereby providing the user with information on when the AI model can perform document classification.

According to one embodiment of the present invention, some of documents among all documents are assigned to a classification block, the remaining documents can be quickly classified through an AI model learned for each classification block.

### DESCRIPTION OF DRAWINGS

FIG. 1 is a drawing illustrating a computing device for AI-based document classification, according to an embodiment of the present invention.

FIG. 2 is a flowchart illustrating an AI-based document classification method, according to an embodiment of the present invention.

FIG. 3 is a drawing for explaining a process of displaying documents in a list format in a document display area of a page according to a user's request, according to an embodiment of the present invention.

FIG. 4 is a drawing for explaining a process of reviewing a plurality of documents and assigning documents to a classification block according to a user's request, according to an embodiment of the present invention.

FIG. 5 is a drawing for explaining a process of reading and displaying documents assigned in a classification block, according to an embodiment of the present invention.

FIG. 6 is a drawing for explaining an example of displaying documents in a list format, according to an embodiment of the present invention.

FIG. 7 is a drawing for explaining an example of assigning all documents to all classification blocks, according to an embodiment of the present invention.

FIG. 8 is a drawing for explaining an example of assigning all documents to classification blocks, according to an embodiment of the present invention.

FIG. 9 is a drawing illustrating an example of classifying remaining documents after assigning a document to a classification block assigned by a user among all documents, according to an embodiment of the present invention.

FIG. 10 is a drawing illustrating an example of a classification block newly created by classifying documents, according to an embodiment of the present invention.

FIG. 11 is a drawing illustrating an example of reading and displaying documents assigned to a newly created classification block in FIG. 10 according to an embodiment of the present invention.

### DETAILED DESCRIPTION

The present invention to be described below may have various modifications and various embodiments, and specific embodiments will be illustrated in the drawings and described in detail. However, the present invention to be described below is not limited to specific embodiments, and it should be understood that the present invention covers all modifications, equivalents and replacements included within the technical idea and technical scope of the present invention.

Terms such as first, second, A, and B may be used for describing various components, but the components are not limited by the terms and the terms are used only for distinguishing one component from other components. For example, a first component may be referred as a second component, and similarly, the second component may also be referred as a first component, without departing from the scope of the invention to be described below. A term ‘and/or’ includes a combination of a plurality of associated disclosed items or any item of the plurality of associated disclosed items.

It is to be understood that singular expression encompass plural expressions unless otherwise indicated in the context, and it should be understood that term “including” or the like indicates that a feature, a number, a step, an operation, a component, a part or the combination thereof described herein is present, but does not exclude a possibility of presence or addition of one or more other features, numbers, steps, operations, components, parts or combinations thereof.

Before the detailed description of the drawings, the distinction to components herein is to clarify that each component is only distinguished for each main function of each component. That is, two or more components to be described below may be combined into one component or one component may be divided into two or more components for each subdivided function. In addition, each of the components to be described below may additionally perform some or all of the functions that are handled by other components in addition to main functions that the corresponding component is responsible for, and some of the main functions of which the respective components are charged may be exclusively carried out by other components.

Further, in performing methods or operating methods, respective processes of configuring the method may be performed differently from a assigned order unless otherwise disclose a specific order in the context. That is, the respective processes may be performed similarly to the assigned order, performed substantially simultaneously, and performed in an opposite order.

The present invention is based on a website/server (or a computer program/application in which a patent search function is implemented by the website/server) providing a patent search engine. Thus, the embodiments described herein may be performed by a web server, an application server, and/or a client device, and a system including them may be collectively referred to as a ‘patent document classification system.’ Hereinafter, for convenience of description, a subject performing the embodiment has been described with the ‘patent search engine’ or the ‘patent document classification system,’ but may be described to be replaced with a web server, an application server, and/or a client device. Further, for convenience of description, the present invention has been described based on a patent search engine provided through a website, but is not limited thereto, and may be applied even to a patent search engine provided through an application.

First, a basic function and a graphic user interface (GUI) of the patent search engine of the present invention will be described and then a method for automatically classifying patent documents will be described in detail.

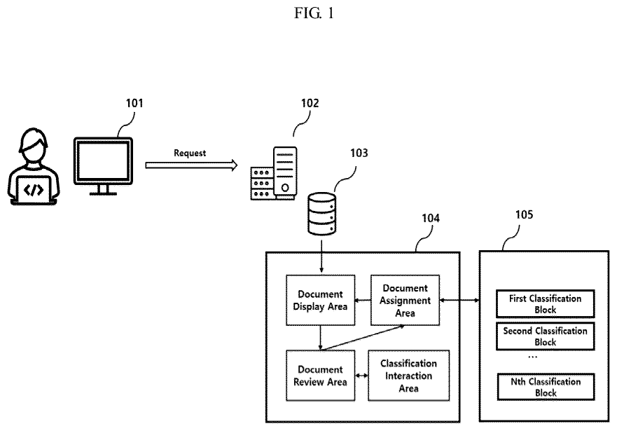

FIG. 1 is a drawing illustrating a computing device for AI-based document classification, according to an embodiment of the present invention.

Computing device 102 may receive a request from user terminal 101. Here, the request may include any one of a document search request, a document display request, a document review request, a document assignment request, and a document classification request. For example, in an embodiment of the present invention, the document may be a patent document including various indexes title, abstract, claims, patent classification (ex. IPC or CPC), application date, application number, applicant, etc.

User terminal 101 may transmit a document search request to computing device 102. Computing device 102 may search for documents stored in the database 103 according to the document search request and display the searched at least one of documents in the document display area. The document display area is a specific area of the page 104 that displays documents searched according to the document search request in the form of a list.

User terminal 101 may transmit a review request for documents displayed in the document display area. Computing device 102 may provide user terminal 101 with a document review area in which documents displayed in the document display area may be reviewed according to the document review request. The document review area may display indexes and contents of documents by mapping indexes. For example, if the document is a patent document, the index may indicate an application number, and the contents may mean US 17-391,414. The user may check the indexes of a plurality of documents displayed in the document review area and the contents mapped to the indexes. At this time, the user may determine a classification block related to the contents of the document by checking the index including the contents of the document and the contents mapped to the index.

User terminal 101 may transmit a document assignment request for assigning a document to a classification block related to the content of the document to computing device 102. Computing device 102 may assign a document to a classification block according to the document assignment request. User terminal 101 may transmit a document assignment request for assigning a document selected by the user to a classification block selected by the user among a plurality of documents to computing device 102. The assigning the documents is storing the document into a folder (classification block).

The classification block may be displayed in the document assignment area 105. The classification block may be generated as one or multiple units according to the request of user terminal 101. At this time, the AI model may learn the document assigned in the classification block. Whenever a document is assigned in the classification block, the AI model may learn the content of the document.

Assigning a document to a classification block may mean storing the document in a classification block. A classification block may be represented as a project, a folder, etc. Assigning a document to a classification block is same as mapping the document's identification number to the classification block's identification number.

When receiving a document assignment request from user terminal 101, computing device 102 may assign documents selected by the user from among a plurality of documents to a classification block selected by the user. Then, an AI model may learn the content of the document assigned to the classification block. If user terminal 101 assigns document 1 to the first classification block, the AI model of computing device 102 may learn the content of document 1 with respect to the first classification block. Through learning the AI model, the content of document 1 is related to the first classification block.

When a user assigns a document to a classification block, it means that the user directly classifies the document according to user's intent for classification. When an AI model learns a document assigned to a classification block, the AI model learns by reflecting the classification intention of the user assigning a document to a classification block.

Each time a document is assigned in a classification block, AI model learning may be performed. And, each time a document is assigned in a classification block, computing device 102 may perform AI model learning. Here, AI model learning may be learning to classify all documents in the document display area or all documents set by the user according to the AI model that learned the documents assigned by classification block.

And computing device 102 may change an indication indicating whether the entire document in the document display area or the entire documents selected by the user may be classified by the AI model. The indication may indicate whether learning was performed well according to the user's intention. The indication may be displayed in various ways such as color, number, letter, special symbol, etc. If the classification block is consistently classified according to the user's intention, the indication may be displayed differently. The indication is displayed independently for each classification block.

In addition, computing device 102 may display a message indicating whether the classification is consistently performed according to the user's intention in the classification interaction area, whether the document is in a state where it may be classified, a menu requesting the user to perform classification, a menu requesting the user to classify in what manner, etc.

The user may check the indication corresponding to the classification block. If the indication is in a state where it may classify the entire document in the document display area or the entire documents selected by the user, User terminal 101 may transmit a document classification request to computing device 102. At this time, user terminal 101 may transmit the document classification request to computing device 102 by selecting a menu displayed in the classification interaction area.

Computing device 102 may classify the entire document in the document display area or the entire document selected by the user according to the document classification request through an AI model that has completed learning the classification block selected by the user. The process of classifying documents may be the process in which the AI model infers.

If all documents in the document display area or all documents selected by the user are classified by the AI model, a new classification block related to the classification block inferred by the AI model may be created. Documents classified by the AI model among all documents in the document display area or all documents selected by the user may be automatically assigned to the new classification block. The user may check whether the documents automatically assigned to the new classification block have been classified according to the user's classification intention.

According to one embodiment of the present invention, in an editing/authoring function/tool e.g., an editing tool/authoring tool capable of verifying a document such as a patent, a similarity assigned by a user in a classification block may be determined through an artificial intelligence model a machine learning or deep learning-based model, a generative AI model, and documents that may be classified to be stored in a classification block among documents that have not yet been classified may be automatically classified.

According to one embodiment of the present invention, when an AI model determines which documents among all unclassified documents may be assigned to a classification block, the result of classifying all documents into the classification block is automatically assigned to the classification block, or the result of classifying all documents is assigned to the classification after user's confirmation process.

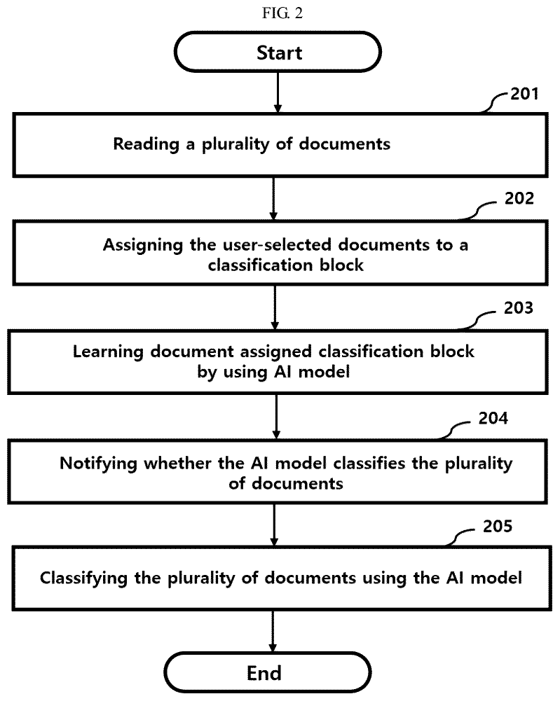

FIG. 2 is a flowchart illustrating an AI-based document classification method according to an embodiment of the present invention.

In step 201, computing device 102 may read a plurality of documents. For example, the plurality of documents may be documents selected by a user from among documents searched from a database 103 in response to a search request received from a user terminal 101. Alternatively, the plurality of documents may be documents read from an entire document block assigned by user terminal 101.

In step 202, computing device 102 may assign a document selected by the user from among a plurality of documents to a classification block according to a request from User terminal 101. User terminal 101 may transmit a document assignment request to assign a document to one of a plurality of classification blocks suitable for the content of the document according to the user's intention to computing device 102. Computing device 102 may assign a document selected by the user to a classification block according to the document assignment request received from User terminal 101.

The process of step 202 may be a process in which a user recognizes the contents of documents displayed in the document review area and assigns the document to one of a plurality of classification blocks according to the contents of the document. One or more classification blocks may be created by user terminal 101.

In step 203, the AI model of computing device 102 may learn a document assigned in a classification block according to a request from a user terminal 101. That is, when a document is assigned in a classification block by user terminal 101, the AI model may learn the content of the document assigned in the classification block in association with the classification block. The processes of steps 202 and 203 may be repeatedly performed.

In step 204, computing device 102 may notify whether the AI model may be classified through document learning. At this time, computing device 102 may notify whether the AI model has become a state in which the AI model may classify the plurality of documents read in step 201. As an example, computing device 102 may notify whether the AI model may be capable of classifying using an indication for each classification block. As another example, computing device 102 may display a message indicating whether the AI model may be capable of classifying documents, in the classification interaction area.

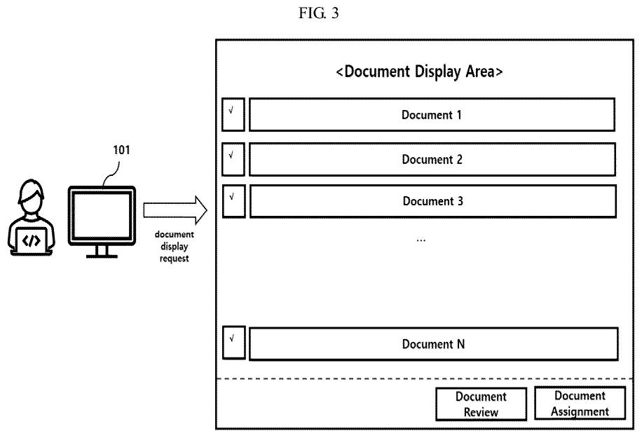

In step 205, when a document classification request for a classification block is received at the request of user terminal 101, computing device 102 may classify the entire document using the AI model. At this time, computing device 102 may create a new classification block and then assign documents classified by the AI model to the new classification block. Computing device 102 may assign documents among the entire documents satisfying a criterion for classification learned by the AI model to the new classification block. Here, criterion for classification may be related to the user's intention to assign a document to a classification block. The process of steps 201 to 205 will be specifically described in FIGS. 3 to 11.

FIG. 3 is a drawing for explaining a process of displaying documents in a list format in a document display area of a page according to a user's request according to an embodiment of the present invention.

User terminal 101 may transmit a document display request to computing device 102. Then, computing device 102 may display a plurality of documents in the document display area. The document display area may display a document review menu that may review documents and a document assignment menu that may assign documents to classification blocks.

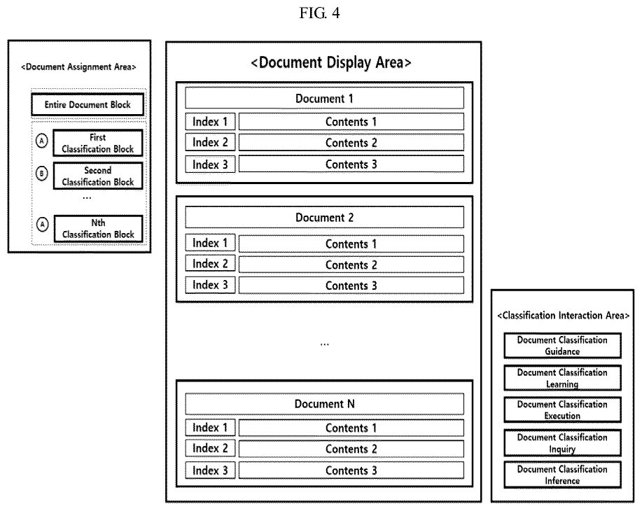

User terminal 101 may review or assign all or a selected document from among the plurality of documents (entire documents) displayed in the document display area. If user terminal 101 transmits a document review request to computing device 102, User terminal 101 may display the page of FIG. 4.

According to one embodiment of the present invention, the document may be a patent document. The document display request may be a patent search request a search term consisting of multiple search words or a natural language-based query. Computing device 102 may display the searched patents in a list format in the document display area according to the patent search request of user terminal 101.

FIG. 4 is a diagram for explaining a process of reviewing multiple documents and storing documents in a classification block according to a user's request according to an embodiment of the present invention.

When user terminal 101 requests document review for a plurality of entire documents, computing device 102 may display a document display area and a document assignment area on a page. In addition, computing device 102 may display a classification interaction area on a page.

User terminal 101 may display entire documents including indexes and contents mapped to the indexes in the document display area. Each of the documents may include multiple indexes and contents mapped to the indexes. The user may review the document by checking the indexes and contents mapped the indexes.

User terminal 101 may assign a document selected by the user from among documents displayed in the document display area to one of the classification blocks displayed in the document assignment area. For example, if the classification block is storage area such as a folder, user terminal 101 may request computing device 102 to store the document in the folder. One or more classification blocks may be created according to the user's request. In addition, the classification blocks may be created by being distinguished by depth. For example, the classification blocks may be created so as to classify a document from one or more category as hierarchy.

When a user assigns a document selected by the user through a user terminal 101 to a classification block, the AI model of computing device 102 may learn by associating the document with the classification block. The AI model may not be displayed on the page of FIG. 4. The classification block may be virtual space where the user may directly classifiy and assign documents.

At this time, the indication displayed adjacent to the classification block may change depending on the learning status of the AI model. The indication may be level of whether the AI model understood the user's classification intention based on the results learned by the AI model.

Whether the AI model understands the user's classification intention may be expressed as a level, which is whether the user has consistently assigned documents with similar content to the classification block. The higher the level, the better the AI model may be judged to have understood the user's classification intention. In other words, if the user understands the document and has assigned similar documents to the classification block, the indication may be displayed at a higher level than a predetermined level. The level may be distinguished in various ways, such as numbers, words, colors, and sizes.

And, the classification interaction area may display various messages or menus related to the classification of the document. The classification interaction area is in the form of a chatbot and may display different messages and menus depending on the process in which the user assigns a document to a classification block.

When a user requests a review of multiple documents, computing device 102 may display a message related to document classification guidance in the classification interaction area. When the user assigns one of the plurality of documents to a classification block, computing device 102 may display a message related to document classification learning in the classification interaction area.

When a user repeatedly assigns documents to a classification block and the AI model becomes capable of classifying documents similar to the documents assigned to the classification block from the entire document, computing device 102 may display a message or menu requesting the AI model to perform classification.

Computing device 102 may display a menu in the classification interaction area that allows the user to select whether to classify the entire document by including the documents learned by the AI model when the AI model classifies the entire document or to classify the entire document by excluding the documents learned by the AI model.

Computing device 102 may display a message indicating the result of classification by the AI model and a message related to document classification inference indicating that a folder specifying a document classified by the AI model has been newly created in the classification interaction area.

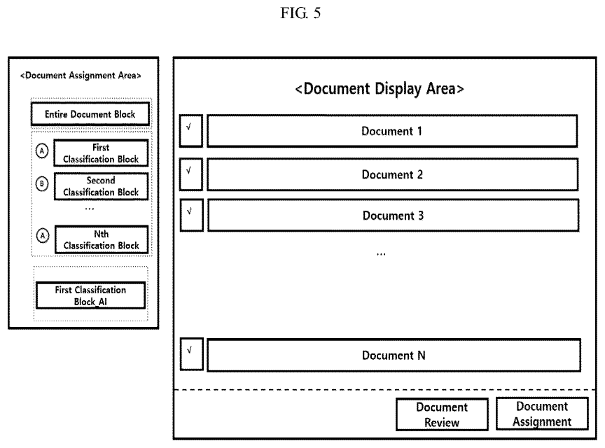

FIG. 5 is a diagram illustrating a process of reading and displaying documents assigned in a classification block according to one embodiment of the present invention.

FIG. 5 illustrates a page including a document assignment area including a plurality of classification blocks and a document display area displaying documents assigned in the classification blocks. When document classification is performed through an AI model in the process of FIG. 4, a new classification block related to the classification block inferred by the AI model may be generated.

Referring to FIG. 5, when all documents assigned in the entire document block are classified by an AI model that has learned documents assigned in the first classification block, the AI model may classify documents similar to documents assigned in the first classification block among all documents. Computing device 102 may generate a first classification block_AI related to the first classification block, and then assign documents classified by the AI model to the first classification block_AI.

When a user selects a new classification block (the first classification block_AI) to check documents assigned in the new classification block, computing device 102 may display the documents assigned in the new classification block in the document display area.

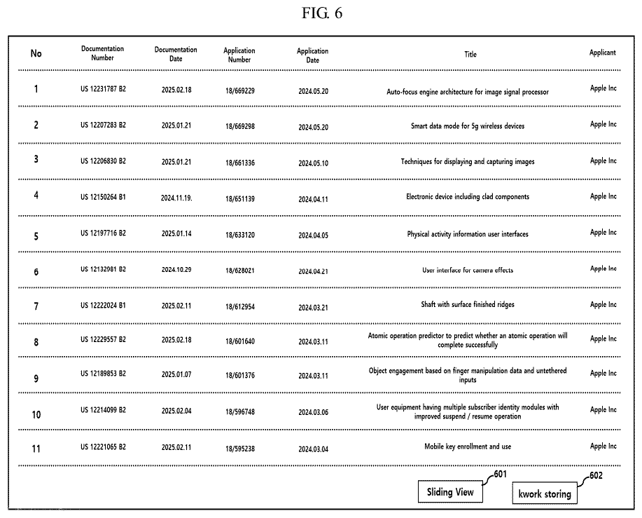

FIG. 6 is a drawing showing an example of displaying a document in a list format according to an embodiment of the present invention.

FIG. 6 shows an example of a document display area providing a list of U.S. registered patents of Apple, Inc. FIG. 6 shows an example of a document display area shown in FIG. 3. Here, the document may be a U.S. registered patent of Apple, Inc. The list of U.S. registered patents may be extracted by searching “Apple” in the field of applicant and “registered” in the field of status for the patent.

When the user reviews the contents of Apple's U.S. registered patents, the user may select menu 601. And, when the user assigns Apple's U.S. registered patents to a classification block, the user may select menu 602.

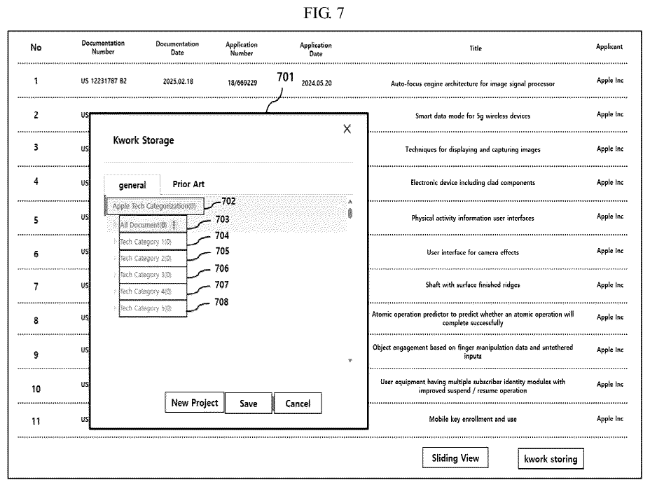

FIG. 7 is a diagram illustrating an example of assigning an entire document to an entire classification block according to one embodiment of the present invention.

In FIG. 6, if the user assigns all of Apple's U.S. registered patents displayed in the document display area, the user may select all of Apple's U.S. registered patents and select the menu 602. Then, a document assignment area 701 including blocks that may assign all of Apple's U.S. registered patents may be displayed, as in FIG. 7. The document assignment area 701 may display a project 702 and a plurality of blocks 703 to 708. At this time, if the user specifies all of Apple's U.S. registered patents to one block 703 among the plurality of blocks, the block 703 may become the entire document block. In FIG. 7, the blocks 704 to 708 may be classification blocks. The block may be a virtual space such as a folder where patent documents may be stored.

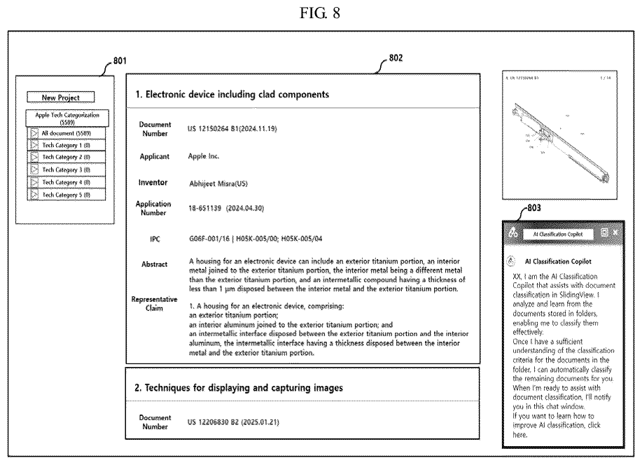

FIG. 8 is a drawing illustrating an example of assigning an entire document to a classification block according to one embodiment of the present invention.

FIG. 8 illustrates an example of a page illustrated in FIG. 4. The page illustrated in FIG. 8 may include a document assignment area 801 and a document display area 802. According to one embodiment of the present invention, the page may include a classification interaction area 803.

The page illustrated in FIG. 8 may be an authoring tool for a document. The authoring tool for a document may be a page that allows a user to load or select a document selected by the user, check the contents of the document, and perform a function of editing/authoring the document. According to one embodiment of the present invention, The authoring tool may be all forms of pages that allow a user to scroll through multiple documents and check the contents of the documents. According to one embodiment of the present invention, in an environment where a document may be edited/authored when a document assignment area 801 and a document display area 802 are displayed together such as a document authoring tool, learning of an AI model may be performed when a document is assigned in the document assignment area 801.

The classification block displayed in the document assignment area 801 may be hierarchically created for a specific project or task. The classification block may be created for each classification according to a request of the user. The classification block may be a virtual area for a label/category that matches the content of the document to be classified through the AI model. Here, the classification block is a virtual space e.g., a folder where documents may be stored, and a document may be assigned to the classification block through a user's action e.g., drag & drop. When the user assigns a document to a classification block, it means that the user maps a category or label corresponding to the classification block to the document according to the content of the document.

Classification blocks may be created as hierarchy into various levels. And, classification blocks may be composed of N layers. Each of the classification blocks corresponding to the highest layer may have an independent relationship with each other or may be set as a relationship with some similar meaning. The name of the classification block may be a name for the technical content of the classification block or is used for the purpose of identifying the classification block.

The classification interaction area 803 may display messages or menus related to the status and guidance of document classification. The classification interaction area 803 may be displayed in the form of a chatbot.

After the user understands the content of the document displayed in the document display area 802 through the index e.g. summary and the content mapped to the index, the user may assign documents with similar content to the classification block displayed in the document assignment area 801.

The classification interaction area 803 may provide a message or a menu for notifying the status of AI model and the actions that the user may take. The message or the menu may be determined differently according to the user's actions in responding to a document or the answers/responses entered by the user through a chatbot e.g. Copilot, etc.,

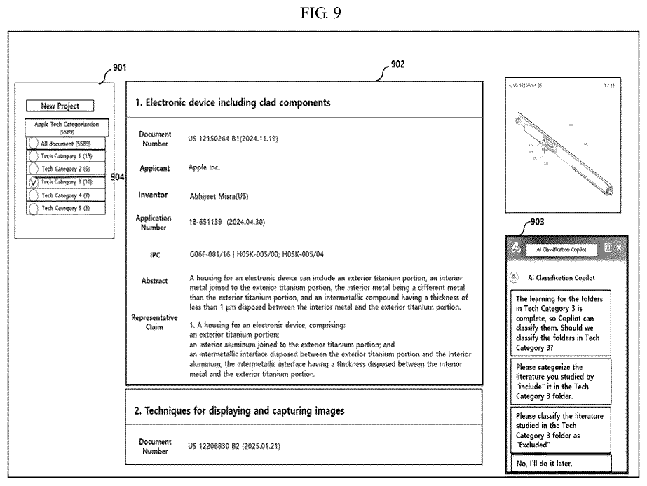

FIG. 9 is a diagram illustrating an example of classifying remaining documents after assigning documents to classification blocks assigned by a user among all documents according to one embodiment of the present invention.

The user may repeatedly perform the process of assigning documents to classification blocks. The process of assigning documents to classification blocks by the user is a process that the user understands the content of the documents and manually classifies the documents according to the user's intention. The AI model may determine the user's classification intention and the accuracy of the classification through the content of the documents assigned to the classification blocks and the similarity between the documents. The AI model may display an indication of whether the AI model is in a classifiable state for the classification block.

A user may understand a document displayed in a document display area 902 through an index and content mapped to the index. A user may assign a document to a classification block displayed in a document assignment area 901. An AI model mapped to a classification block may learn a document assigned to a classification block. If similar documents are assigned to a classification block, an indication 904 corresponding to the classification block may be changed. In the page illustrated in FIG. 9, an indication 904 of a classification block Tech Category 3 displayed in the document assignment area 901 has been changed. The indication 904 indicates that the AI model mapped to the classification block Tech Category 3 may classify all documents. It indicates that the AI model mapped to the classification blocks Tech Category 1, 2, 4, and 5 may not classify all documents.

And, the classification interaction area 903 may display a message 905 related to document classification performance and a message 906, 907 related to document classification inquiry. When a user selects a message 906 related to a document classification inquiry, computing device 102 may classify documents including those used by the AI model of the classification block Tech Category 3 when learning. When a user selects a message 907 related to a document classification inquiry, computing device 102 may classify documents excluding those used by the AI model of the classification block Tech Category 3 when learning.

Users may check the contents of documents included in the entire document block in various ways e.g. authoring tools/editing tools and assign documents one by one to each of multiple classification blocks. At this time, if the similarity/correlation of documents classified in the classification block is above the criterion for the classification, the status that AI classification is possible may be expressed with the folder (classification block). The status may be expressed as indication for the classification block.

Similarity/correlation may be determined based on the relationship between documents included in the entire document block, documents assigned in a classification block that is distinct from the entire document block, and documents included in the entire document block but not assigned in the classification block, such as the similarity or correlation between documents stored in a classification block, the similarity or correlation between documents included in the entire document block, and the similarity or correlation between documents stored in the classification block.

Users may assign documents by classifying them by setting the classification block to the desired classification such as purpose/product/industry/part/detailed technology. As the user continues to assign documents to the classification block, the AI model may display an indication that the AI model may be capable of classifying documents for the classification block itself or near the classification block. The indication may be changed in real time as the user continues to assign documents in the entire document block to the classification block.

When an AI model is capable of classifying documents for the classification blocks, notification may be provided through a classification interaction area 903. The classification interaction area 903 is displayed by overlapping with the authoring tool page of FIG. 9 or is provided through a separate window. Depending on the situation in which the user assigns a document to the classification block, the classification interaction area 903 may provide various messages or menus. The classification interaction area 903 may notify the user of the status of the consistency, diversity, etc. of the classification process according to the change in the similarity/correlation determined through the documents assigned to the classification block.

The classification interaction area 903 may notify the user whether the process of saving a document in a classification block is appropriate, or may display the user of various notification such as errors in classification criteria, guidance on incorrect classification, and whether there is a conflict with documents already saved in the classification block while the user is saving the document.

According to one embodiment of the present invention, an AI model may estimate a user's classification criteria or classification intention through a process in which a user assigns a document to a classification block.

When a classification block is determined at which the AI model may automatically classify the remaining documents, and a user receives a classification request through the classification interaction area 903, the AI model may classify documents in the entire document block at once for the classification block. Documents that are not classified in batches may still remain in the entire document block, and the number of documents remaining after excluding the documents classified in batches in the entire document block may be expressed.

Similarity comparisons may be performed between documents that a user has assigned in a classification block with the intention of classification. Similarity comparisons may be process in which an AI model learns documents assigned in a classification block.

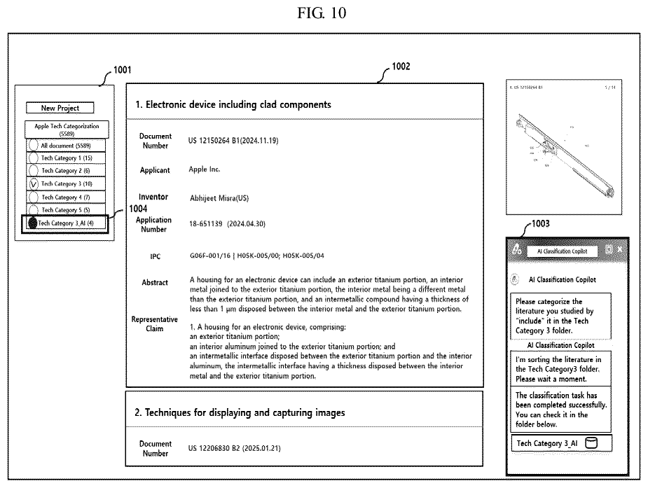

FIG. 10 is a drawing illustrating an example of a newly created classification block by classifying a document according to one embodiment of the present invention.

After the user understands the contents of the documents displayed in the document display area 1002 through the index and contents, user may select similar documents and assign documents to the classification block. Depending on the learning result of the AI model mapped to the classification block Tech Category 3, the indication 1004 indicating whether the AI model is capable of classification of the entire document. In addition, a message indicating whether the AI model is capable of classification of the entire document may be displayed in the classification interaction area.

When classification of the entire document is performed according to the user's request, computing device 102 may generate a new classification block Tech Category 3_AI related to the classification block Tech Category 3. The new classification block Tech Category 3_AI is displayed in the document assignment area 1001. According to one embodiment of the present invention, a classification block created by the user and a new classification block automatically created through an AI model may be generated separately. The new classification block includes documents classified by the AI model which learned document assigned in the classification block.

Here, Tech Category 3 may be a user labeling block (classification block) where a user assigned a document according to the content of the document, and Tech Category 3_AI may be an AI labeling block (new classification block) where a document is automatically assigned by an AI model.

Computing device 102 may display a message 1005 related to a classification method selected by a user, a message 1006 related to the progress of document classification, a message 1007 related to the completion of document classification, and a message 1008 indicating that a new classification block has been created according to document classification in the classification interaction area 1003.

Although not shown in FIG. 10, the classification interaction area 1003 may display a menu that allows the AI model to adjust the inference scope when performing classification. For example, the menu is one menu among Menu 1 that allows the AI model to perform the narrowest inference that the AI model determines is clear when performing classification, Menu 2 that allows the AI model to perform the broadest inference that the AI model determines is classifiable, and Menu 3 that allows the AI model to select either the narrowest or broadest range. The classification interaction area 1003 may be turned On/Off according to a user's request.

An AI model may classify at least one classification block among multiple classification blocks. In this case, the classification block that the AI model may classify is a classification block for which the AI model has already completed learning. In addition, the classification blocks that the AI model may classify may be one or more. In this case, documents that are not assigned by the user among multiple documents in the entire document block may be classified by the AI model. In this case, when the AI model classifies, classification may be performed on a classification block that the AI model may classify and that the user has selected.

At this time, classification blocks may be selected by the user for classifying the entire documents simultaneously. Or, classification blocks for classifying by the AI model may be excluded according to the user's request.

For example, when the number of documents assigned by the user in the classification block exceeds a certain number of documents, the AI model may be ready to classify all documents for the classification block. The certain number of documents may be determined depending on the number of total documents, the number of classification blocks, the similarity between documents assigned in the classification block, and the types of documents assigned in the classification block.

A classification block may be empty or may include document assigned by the user already. When a document is assigned for a classification block by the user, the indication for the classification block may change depending on documents assigned by the user for the classification block.

If a document that the user currently assigns to a classification block is similar to a document that the user has already assigned to a classification block, the probability that the AI model will change its indication that the classification block is classifiable may increase. The indication may reflect the status that the AI model is classifiable for the classification block or the similarity between the documents assigned to the classification block.

However, if the documents that the user assigns for a classification block are inconsistent or dissimilar to each other, the indication may not change the status of the AI model being classifiable for the classification block.

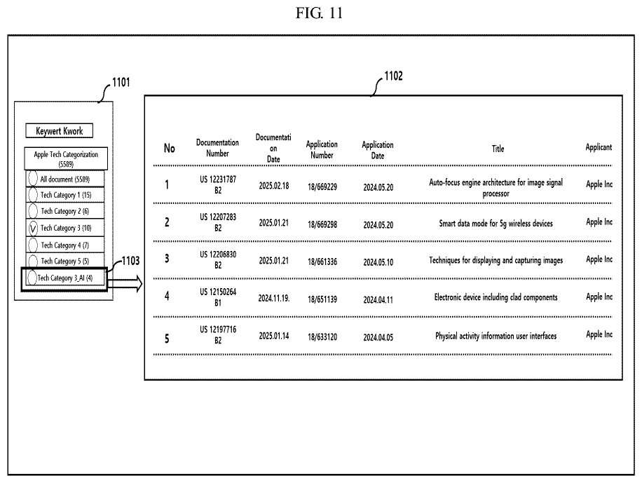

FIG. 11 is a drawing illustrating an example of reading and displaying documents assigned in a newly created classification block in FIG. 10 according to one embodiment of the present invention.

The process of displaying documents assigned in a new classification block 1003 generated according to the document classification result in FIG. 11 is shown. When a user selects one of the classification blocks displayed in the document assignment area 1101, computing device 102 may display documents assigned in the classification block selected by the user in the document display area 1102.

At this time, the document assignment area 1101 may display not only the classification block created by the user, but also a new classification block 1103 created by the AI model of computing device 102 classifying the entire document. When the user selects the new classification block 1103, computing device 102 may check the documents assigned in the new classification block 1103.

The embodiments of the present invention may be implemented by, for example, hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Further, in the case of implementation by firmware or software, the embodiment of the present invention may be implemented in the form of a module, a procedure, a function, and the like to perform the functions or operations described above and recorded in recording media readable by various computer means. Herein, the recording medium may include singly a program instruction, a data file, or a data structure or a combination thereof. The program instruction recorded in the recording medium may be specially designed and configured for the present invention, or may be publicly known to and used by those skilled in the computer software field. Examples of the recording media include magnetic media such as a hard disk, a floppy disk, and a magnetic tape, optical media such as a CD-ROM (Compact Disk Read Only Memory) and a DVD (Digital Video Disk), magneto-optical media such as a floptical disk, and a hardware device which is specifically configured to store and execute the program instruction such as a ROM, a RAM, and a flash memory. An example of the program instruction includes a high-level language code executable by a computer by using an interpreter and the like, as well as a machine language code created by a compiler. The hardware devices may be configured to operate as one or more software modules in order to perform the operation of the present invention, and an opposite situation thereof is available.

In addition, an apparatus or terminal according to the present invention may be driven by instructions that cause one or more processors to perform the functions and processes described above. The instructions may include, for example, interpreted instructions such as script instructions, such as JavaScript or ECMAScript instructions, executable codes or other instructions stored in computer readable media. Further, the device according to the present invention may be implemented in a distributed manner across a network, such as a server farm, or may be implemented in a single computer device.

In addition, a computer program (also known as a program, software, software application, script or code) that is embedded in the device according to the present invention and which implements the method according to the present invention may be prepared in any format of a compiled or interpreted language or a programming language including a priori or procedural language and may be deployed in any format including standalone programs or modules, components, subroutines, or other units suitable for use in a computer environment. The computer program does not particularly correspond to a file in a file system. The program may be stored in a single file provided to a requested program, in multiple interactive files (e.g., a file storing one or more modules, subprograms, or portions of code), or in a part (e.g., one or more scripts stored in a markup language document) of a file storing another program or data. The computer program may be located on one site or distributed over a plurality of sites to be executed on multiple computers or one computer interconnected by a communication network.

Although the drawings have been described for the sake of convenience of explanation, it is also possible to design a new embodiment to be implemented by merging the embodiments described in each drawing. Further, configurations and methods of the described embodiments may not be limitedly applied to the aforementioned present invention, but all or some of the respective embodiments may be selectively combined and configured so as to be variously modified.

Further, while the embodiments of the present invention have been illustrated and described above, the present invention is not limited to the aforementioned specific embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

The present invention may be applied to various patent search engine technology fields and/or machine learning technology fields.

What is claimed is:

1. An AI (Artificial Intelligence)-based document classification method performed by a computing device comprises:
reading a plurality of documents;
assigning a user-selected document among the plurality of documents to classification blocks;
learning an AI model using the user-selected document assigned to the classification block;
notifying whether the AI model classifies the plurality of documents, wherein the AI model learned with the user-selected document in relation to the classification block; and
classifying the plurality of documents using the AI model learned with the user-selected document assigned to the classification block, according to a request of the user.

2. The AI-based document classification method of claim 1, wherein the learning the AI model comprises:
learning the AI model the user-selected document with the classification block, when the user selects the document and assigns the document to the classification block.

3. The AI-based document classification method of claim 1, further comprises:
generating a new classification block corresponding to the classification block, when the AI model classifies the plurality of documents into the classification block.

4. The AI-based document classification method of claim 3, wherein the new classification block includes the documents assigned to the classification block or excludes the documents assigned to the classification block.

5. The AI-based document classification method of claim 1, wherein the notifying comprises:
determining an indication of the classification block to represent whether the AI model is capable of classification for the classification block or to represent the level of understanding of the user's classification intent by the AI model.

6. The AI-based document classification method of claim 1, wherein the notifying comprises:
displaying a message to describe that the AI model is capable of classifying the classification block, in a classification interaction area.

7. The AI-based document classification method of claim 6, wherein the classification interaction area displays at least one of (i) a message explaining the method of classifying documents using the AI model, (ii) a message for selecting the method of classifying documents using the AI model, or (iii) a message indicating that the AI model has completed document classification.

8. An AI (Artificial Intelligence)-based document classification method performed by a computing device comprises:
displaying an indication to represent whether an AI model can classify for the classification block selected by the user; and
classifying documents selected by the user using the AI model, when a request for document classification with respect to the classification block is received from the user,
wherein the AI model is a model learned for association documents with classification blocks, when the user assigns documents to the classification block.

9. The AI-based document classification method of claim 8, further comprises:
generating a new classification block corresponding to the classification block, when the AI model classifies the plurality of documents into the classification block.

10. The AI-based document classification method of claim 9, wherein the new classification block includes the documents assigned to the classification block or excludes the documents assigned to the classification block.

11. The AI-based document classification method of claim 8, wherein the displaying comprises:
determining an indication of the classification block to represent whether the AI model is capable of classification for the classification block or to represent the level of understanding of the user's classification intent by the AI model.

12. The AI-based document classification method of claim 8, wherein the displaying comprises:
displaying a message to describe that the AI model is capable of classifying the classification block, in a classification interaction area.

13. A computing device performing an AI-based document classification method, wherein computing device comprising a processor,
wherein the processor is configured to:
display an indication to represent whether an AI model can classify for the classification block selected by the user; and
classify documents selected by the user using the AI model, when a request for document classification with respect to the classification block is received from the user,
wherein the AI model is a model learned for association documents with classification blocks, when the user assigns documents to the classification block.

14. Computing device of claim 13, wherein the processor generates a new classification block corresponding to the classification block, when the AI model classifies the plurality of documents into the classification block.

15. Computing device of claim 14, wherein the new classification block includes the documents assigned to the classification block or excludes the documents assigned to the classification block.

16. Computing device of claim 13, wherein the processor determines an indication of the classification block to represent whether the AI model is capable of classification for the classification block or to represent the level of understanding of the user's classification intent by the AI model.

17. Computing device of claim 13, wherein the processor displays a message to describe that the AI model is capable of classifying the classification block, in a classification interaction area.
